(19) United States
(12) Patent Application Publication
(10) Pub. No.: US 2025/0376847 A1
(43) Pub. Date: Dec. 11, 2025

(54) Roof-Installed Heat Cable System

(71) Applicant: Wimmer Corporation, Morgan, UT (US)

(72) Inventor: Eric Lyle Wimmer, Morgan, UT (US)

(73) Assignee: Wimmer Corporation, Morgan, UT (US)

(21) Appl. No.: 19/231,665

(22) Filed: Jun. 9, 2025

Related U.S. Application Data
(60) Provisional application No. 63/658,149, filed on Jun. 10, 2024.

(51) Int. Cl. E04D 13/076; H05B 3/56

(52) U.S. Cl. CPC E04D 13/0762; H05B 3/56; H05B 2203/003; H05B 2214/02

(57) ABSTRACT

A roof-installed heat cable system includes a plurality of metal plate cartridges disposed on a portion of a roof may include a first secured metal plate; a second secured metal plate; and one or more unsecured metal plates disposed between the first secured metal plate and the second secured metal plate, wherein each of the first secured metal plate, the second secured metal plate, and the one or more unsecured metal plates includes a cable-receiving groove, the cable-receiving grooves being configured to align and form channels between the first secured metal plate and the one or more unsecured metal plates and between the second secured metal plate and the one or more unsecured metal plates; and a heat cable disposed between the first secured metal plate and the one or more unsecured metal plates and between the second secured metal plate and the one or more unsecured metal plates.

### CROSS-REFERENCE TO RELATED APPLICATION

This application claims to benefit of priority of U.S. Provisional Patent Application No. 63/658,149 filed on Jun. 10, 2024, and entitled “Roof-Installed Heat Cable System,” the entire disclosure of which is hereby incorporated by reference.

### FIELD OF THE DISCLOSURE

The present disclosure generally relates to a roof-installed heat cable system. The present disclosure more specifically relates to systems and methods of use of a roof-installed heat cable system formed under a surface of a roof that provides for easy installation, access, and maintenance.

### BACKGROUND

In cold climates, freezing temperatures combined with precipitation often lead to the formation of ice dams along roof edges. These ice dams can obstruct the natural flow of melting snow and water, causing water to back up beneath roofing materials and potentially leading to structural damage, interior leaks, and costly repairs. Metal roofs, while durable, are particularly susceptible to these issues due to their smooth surfaces and rapid temperature fluctuations. Existing heat cable systems intended to mitigate ice dam formation frequently suffer from inefficient thermal transfer, complex or invasive installation requirements, limited compatibility with metal roofing systems, and poor long-term serviceability. Furthermore, many such systems are not designed for easy access, upgrade, or repair once installed, and often fail to support diverse heat cable geometries or integration beneath a finished roof surface.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating a roof-installed heat cable system according to an embodiment of the present disclosure;

FIG. 2 is a graphic top view diagram illustrating two of a plurality of cartridges within a roof-installed heat cable system comprising a plurality of secured metal plates, a plurality of unsecured metal plates, and a heat cable according to an embodiment of the present disclosure;

FIG. 3 is a side block diagram illustrating two of a plurality of cartridges within a roof-installed heat cable system comprising a plurality of secured metal plates and a plurality of unsecured metal plates formed under a roofing material according to an embodiment of the present disclosure;

FIG. 4 is a side block diagram illustrating a removable edge plate covering the cartridges within a roof-installed heat cable system shown in FIG. 3 according to an embodiment of the present disclosure;

FIG. 5 is perspective graphical diagram illustrating a roof-installed heat cable system as installed with a heat cable on a roof according to an embodiment of the present disclosure;

FIG. 6 is perspective view, graphical diagram illustrating a metal plate used as a secured or unsecured metal plate of the roof-installed heat cable system according to an embodiment of the present disclosure;

FIG. 7 is a side view, graphical diagram illustrating a metal plate used as a secured or unsecured metal plate of the roof-installed heat cable system according to an embodiment of the present disclosure;

FIG. 8A is a front a graphical diagram of a rounded end cap operatively couplable to a secured or unsecured metal plate of the roof-installed heat cable system according to an embodiment of the present disclosure;

FIG. 8B is a side a graphical diagram of a rounded end cap operatively couplable to a secured or unsecured metal plate of the roof-installed heat cable system according to an embodiment of the present disclosure;

FIG. 8C is a front perspective view graphical diagram of a rounded end cap operatively couplable to a secured or unsecured metal plate of the roof-installed heat cable system according to an embodiment of the present disclosure;

FIG. 8D is a bottom graphical diagram of a rounded end cap operatively couplable to a secured or unsecured metal plate of the roof-installed heat cable system according to an embodiment of the present disclosure;

FIG. 8E is a side view graphical diagram of securement fins of a rounded end cap operatively couplable to a secured or unsecured metal plate of the roof-installed heat cable system according to an embodiment of the present disclosure;

FIG. 9A is a front, perspective view of a metal plate wedge of the roof-installed heat cable system according to an embodiment of the present disclosure;

FIG. 9B is a front view of a metal plate wedge of the roof-installed heat cable system according to an embodiment of the present disclosure;

FIG. 9C is a bottom view of a metal plate wedge of the roof-installed heat cable system according to an embodiment of the present disclosure;

FIG. 9D is a side view of a metal plate wedge of the roof-installed heat cable system according to an embodiment of the present disclosure;

FIG. 10 is a perspective view of the roof-installed heat cable system placed under a roofing material and concealed using a removable edge plate according to an embodiment of the present disclosure;

FIG. 11 is a side, cross-sectional view of the roof-installed heat cable system placed under a roofing material and concealed using removable edge plate according to an embodiment of the present disclosure; and

FIG. 12 is a flow diagram illustrating a method of installing a roof-installed heat cable system according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

In many cold climate regions throughout the world, particularly those subject to frequent freeze-thaw cycles and sustained periods of sub-freezing temperatures, roofs are prone to the formation of ice dams. Ice dams typically occur when heat escapes from the interior of a building and warms the underside of the roof deck, causing snow accumulated on the roof to melt. As the melted water travels downward, it reaches colder, unheated eaves and refreezes. This process repeats, resulting in the progressive buildup of ice along the lower edge of the roof. Once formed, ice dams can prevent proper drainage of subsequent meltwater, forcing it to pool and pass beneath shingles, flashing, or roofing panels. This passing of water underneath the shingles, flashing, or roofing panels (e.g., metal roofing panels) can damage the roof structure, insulation, and interior ceiling finishes, often leading to mold growth and costly repairs.

Various techniques have been employed to mitigate or eliminate ice dams. These include chemical de-icing agents such as salt or calcium chloride, manually applied to the roof edge or placed in permeable sleeves. While these agents can locally melt ice, they can also corrode metal roofing, gutters, fasteners, and downspouts, and leach into adjacent landscaping. Mechanical methods, including steam removal and physical chipping, are labor-intensive, potentially hazardous, and may damage the roofing material if improperly executed. Some roof designs incorporate passive features such as ventilation or thermal barriers to minimize heat transfer, but these are often ineffective under extreme weather conditions or in retrofitted structures. Electrically heated cable systems have also been introduced as an active solution. However, conventional implementations suffer from inefficient heat distribution, limited adaptability to roof geometries, unsightly to an observer, and difficult servicing once installed. These shortcomings underscore the need for an improved, serviceable, and efficient roof-installed heat cable system that can be modularly embedded under roofing surfaces while ensuring accessible and effective thermal control to prevent ice dam formation.

The present specification describes roof-installed heat cable system. In an embodiment, the roof-installed heat cable system may include a plurality of metal plate cartridges disposed on a portion of a roof. In an embodiment, the plurality of metal plate cartridges may be formed on a sub-level decking surface of a roof that is recessed below a primary roof decking such that a top roofing material such as metal sheeting may be placed over the plurality of metal plate cartridges. In an embodiment, each of the plurality of metal plate cartridges may include a first secured metal plate, a second secured metal plate, and one or more unsecured metal plates. Any number of metal plate cartridges may be formed along an edge of the roof in some embodiments herein.

In an embodiment, the each of the first secured metal plate, the second secured metal plate, and the one or more unsecured metal plates includes a cable-receiving groove, the cable-receiving grooves being configured to align and form channels between the first secured metal plate and the one or more unsecured metal plates and between the second secured metal plate and the one or more unsecured metal plates. This allows for a heat cable disposed between the first secured metal plate and the one or more unsecured metal plates and between the second secured metal plate and the one or more unsecured metal plates. In an embodiment, the heat cable may, in a serpentine fashion, pass from one metal plate cartridge to another with the heat cable passing between the first secured metal plate and the one or more unsecured metal plates, passing between the one or more unsecured metal plates and the second secured metal plate second secured metal plate before passing to another formed metal plate cartridge formed along the edge of the roof.

In an embodiment, the roof-installed heat cable system may also include one or more wedges configured to mechanically secure the one or more unsecured metal plates against the first secured metal plate and the second secured metal plate when installed. These wedges, in an embodiment, may be configured to be inserted between the one or more unsecured metal plates to force them into engagement with the first secured metal plate and the second secured metal plate. In an embodiment, the wedges may include multiple surfaces that may be used to wedge the one or more unsecured metal plates to force them into engagement with the first secured metal plate and the second secured metal plate thereby providing, at least, two different wedging states based on insertion depth with each wedging state applying a different lateral force to secure the one or more unsecured metal plates between the first and second secured metal plate.

In an embodiment, the one or more unsecured metal plates may include rounded plastic inserts at their terminal ends, the rounded plastic inserts being shaped to guide the heat cable around the terminal ends of the unsecured metal plates. These rounded plastic inserts may prevent damage to the heat cable as it is bent around the terminal ends of the one or more unsecured metal plates, first secured metal plate, and/or second secured metal plate as the heat cable serpentines trough these metal plates.

In an embodiment, the first secured metal plate and second secured metal plate of each of the plurality of metal plate cartridges are secured to a sub-level decking surface of a roof that is recessed below a primary roof decking to accommodate the plurality of metal plate cartridges in a flush-mounted configuration. This sub-level decking ay be vertically lower than the primary roof decking such that a metal roofing material may be formed over the top of the cartridges.

In an embodiment, the roof-installed heat cable system may also include a removable edge plate installed along a lateral edge of the roof to seal the plurality of metal plate cartridges under the metal roofing layer, wherein the removable edge plate is configured to prevent the ingress of water while maintaining access to the plurality of metal plate cartridges. In an embodiment, the removable edge plate secured along the lateral edge of the roof includes a mating interface to mate with a hem formed at an edge of a drip edge disposed under the metal roofing layer to seal the plurality of metal plate cartridges under the metal roofing layer.

Thus, the roof-installed heat cable system may provide for a roof-installed heat cable system that prevents ice dams and other accumulation of ice or snow at any portion of a roof including edges of the roof. This prevents damage to interior portions within the home as well as prevent dangerous accumulation of snow that may fall down and injure a person. Still further, because of the placement of the one or more unsecured metal plates between the first secured metal plate and the second secured metal plate thereby forming a metal plate cartridge, the system may be made accessible to a maintenance worker, technician, or homeowner. Because the heat cable is formed between the one or more unsecured metal plates and each of the first secured metal plate and second secured metal plate, the removal of the one or more unsecured metal plates allows the maintenance worker, technician, or homeowner to access the heat cable, remove the heat cable, and either repair the heat cable or replace the heat cable. After the heat cable is replaced, each of the sets of one or more unsecured metal plates may be used to, again, push and sandwich the heat cable between the one or more unsecured metal plates and each of the first secured metal plate and second secured metal plate. Therefore, by simply removing the removable edge plate (that also operates as an environmental barrier to the roof-installed heat cable system), the maintenance worker, technician, or homeowner may easily replace the heat cable if and when the heat cable has failed to produce heat and sufficiently heat each of the one or more unsecured metal plates, first secured metal plate, and second secured metal plate in order to heat the roof.

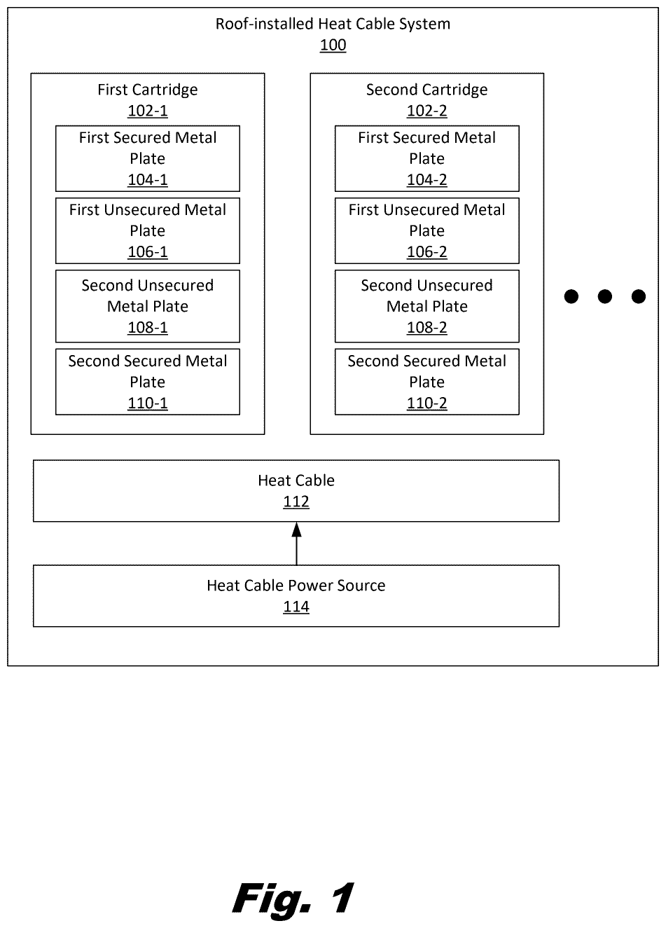

Turning now to the figures, FIG. 1 illustrates a roof-installed heat cable system 100 according to an embodiment of the present disclosure. FIG. 1 is a block diagram illustrating a roof-installed heat cable system 100 according to an embodiment of the present disclosure. As described herein, the roof-installed heat cable system 100 may be formed onto a roof such as an edge portion of the roof such that ice accumulation is prevented. In an embodiment, this roof-installed heat cable system 100 may be used in conjunction with a metal panel roof system. In an embodiment, a standing seam metal roof (SSMR) or other types of roofing materials may also be used and the present specification contemplates the use of these other types of roofing materials. It is further appreciated that, in order to facilitate the use of the heat cable system 100 with these other types of roofing materials, additional layers of roofing materials such as metal sheets may be used to separate the heat cable system 100 from contact with these other types of roofing materials. However, the present specification describes the roof-installed heat cable system 100 being used in connection with an SSMR roof. In an embodiment, the heat dissipated by the heat cable and the first secured metal plate 104-1, 104-2, first unsecured metal plate 106-1, 106-2, second unsecured metal plate 108-1, 108-2, and second secured metal plate 110-1, 110-2 may be further dissipated into the metal of the SSMR roofing material more readily. This dissipation into the metal SSMR roofing material may more readily dissipate that heat as opposed to the other types of roofing materials. However, the present specification contemplates that these other types of roofing materials may be used as the heat dissipation may still be significant enough to prevent the accumulation of ice or snow on the roof.

As briefly described earlier, the roof-installed heat cable system 100 may include a plurality of cartridges 102-1, 102-2. In the embodiment, FIG. 1 shows a first cartridge 102-1 and a second cartridge 102-2. However, the present specification contemplates that any number of cartridges 102-1, 102-2 may be formed on a roof of a home. In an embodiment, a plurality of cartridges 102-1, 102-2 may be formed along an edge of a roof at locations where ice or snow may accumulate in some examples herein. Thus, although FIG. 1 shows only a first cartridge 102-1 and a second cartridge 102-2, the present specification contemplates more than those cartridges 102-1, 102-2 shown.

Each of the cartridges 102-1, 102-2 may comprise a first secured metal plate 104-1, 104-2, a first unsecured metal plate 106-1, 106-2, a second unsecured metal plate 108-1, 108-2, and a second secured metal plate 110-1, 110-2. As described herein, these metal plates 104-1, 104-2, 106-1, 106-2, 108-1, 108-2, 110-1, 110-2 may be made of a type of metal or an alloy of metals that allow for heat dissipation. These metals may include, for example, lightweight, high thermal conductive, corrosion resistant, and cost effective metals such as aluminum (Al), copper (Cu), stainless steel, galvanized steel, zinc, brass, and/or nickel-silver alloys. For maximum cost effectiveness, thermal conductivity, and lightweight material, for example, Al may be used.

In an embodiment, the first secured metal plate 104-1, 104-2, the first unsecured metal plate 106-1, 106-2, the second unsecured metal plate 108-1, 108-2, and the second secured metal plate 110-1, 110-2 (herein referred to also as metal plates 104-1 through 110-2) may include a cable-receiving groove formed along a side of the metal plates 104-1 through 110-2. This cable-receiving groove may be formed to receive or house a portion of the heat cable 112. As described herein, the cable-receiving groove may be formed on a side surface of each of the metal plates 104-1 through 110-2 such that two of the metal plates 104-1 through 110-2 may align and form channels between those metal plates 104-1 through 110-2. In an embodiment, the formed channel may entirely circumvent or surround the heat cable 112 such that the entire outer surface of the heat cable is in physical contact with two metal plates 104-1 through 110-2, thereby distributing the heat from the heat cable 112 touching the metal plates 104-1 through 110-2 into those metal plates 104-1 through 110-2. It is appreciated that, in some example embodiments, the entire outer surface of the heat cable 112 that is sandwiched between two of the metal plates 104-1 through 110-2 may not be in physical contact with the metal plates 104-1 through 110-2. Although this reduced or limited physical contact between the metal plates 104-1 through 110-2 and heat cable 112 may be present in the roof-installed heat cable system 100, heat may still be distributed into the metal plates 104-1 through 110-2 and is still sufficient to heat the metal roof and prevent ice dams from forming.

The metal plates 104-1 through 110-2 may be arranged such that the first unsecured metal plate 106-1, 106-2 and second unsecured metal plate 108-1, 108-2 are placed between the first secured metal plate 104-1, 104-2 and the second unsecured metal plate 108-1, 108-2. In an embodiment, the first secured metal plate 104-1, 104-2 may have a cable-receiving groove that mates with a cable-receiving groove of the first unsecured metal plate 106-1, 106-2 such that the heat cable 112 may pass through the channel formed by their union. Thus, the heat cable 112 may pass up through this channel formed by the cable-receiving grooves of the first secured metal plate 104-1, 104-2 and first unsecured metal plate 106-1, 106-2. The second secured metal plate 110-1, 110-2 may similarly have a cable-receiving groove that mates with a cable-receiving groove of the second unsecured metal plate 108-1, 108-2 such that the heat cable 112 may be passed down through this channel formed between the second secured metal plate 110-1, 110-2 and the second unsecured metal plate 108-1, 108-2. Because the first secured metal plate 104-1, 104-2 and second unsecured metal plate 108-1, 108-2 are secured to a decking surface of the roof such as a sub-level decking surface described herein, the first unsecured metal plate 106-1, 106-2 and second unsecured metal plate 108-1, 108-2 may be pressed up against the first secured metal plate 104-1, 104-2 and second secured metal plate 110-1, 110-2 with the heat cable 112 pushed up the roof as the first unsecured metal plate 106-1, 106-2 and second unsecured metal plate 108-1, 108-2 are moved into place. In an embodiment, the first unsecured metal plate 106-1, 106-2 and second unsecured metal plate 108-1, 108-2 may be wedged against the first secured metal plate 104-1, 104-2 and second unsecured metal plate 108-1, 108-2 using a wedge. This wedge may be used to provide the force necessary to secure the first unsecured metal plate 106-1, 106-2 against the first secured metal plate 104-1, 104-2 and the second unsecured metal plate 108-1, 108-2 against the second secured metal plate 110-1, 110-2. The wedge may be the last portion of each of the cartridges 102-1, 102-2 that secures the cartridges 102-1, 102-2 in place and may be the first element to be removed when maintaining the roof-installed heat cable system 100 described herein. In an embodiment, a removable edge plate may visually hide the cartridges 102-1, 102-2 from view and provide isolation of the cartridges 102-2, 102-2 and the heat cable 112 from the elements. The removable edge plate may be secured to, for example, a facia plate of a roof using any type of fastener.

The roof-installed heat cable system 100 further includes a heat cable 112. The heat cable 112 may be any type of heat cable 112 and the present specification contemplates that any type of heat cable 112 used. In specific examples, the heat cable 112 may be self-regulating heat cables, constant wattage heat cables, mineral insulate (MI) heat cables, series resistance heat cables, or cables that include variations of these features. It is appreciated that the heat cable 112 may be of various wattage and physical sizes with various cross-sectional shapes. In an embodiment, the cross-sectional shapes of the heat cable 112 may be oval, elongated circular, or round. The selected cross-sectional shape of the heat cable 112 may be selected based on the cable-receiving groove formed into the side of the first secured metal plate 104-1, 104-2, the first unsecured metal plate 106-1, 106-2, the second unsecured metal plate 108-1, 108-2, and the second secured metal plate 110-1, 110-2 described herein. For example, where the channel formed between two metal plates 104-1 through 110-2 with the cable-receiving grooves has an elongated circular shape or an oval shape, the cross-sectional shape of the heat cable 112 may have a complimentary shape such that a maximum amount of the outer surface of the heat cable 112 touches the interior surface of the channel formed between the cable-receiving grooves of the metal plates 104-1 through 110-2.

The heat cable 112 may be operatively coupled to a heat cable power source 114. This heat cable power source 114 may be any type of direct current (DC) or alternating current (AC) power source that can power the entire length of the heat cable 112 and throughout the roof-installed heat cable system 100. In an embodiment, a dedicated AC power outlet may be provided in order to power the heat cable 112.

Thus, the roof-installed heat cable system 100 may prevent ice dams and other accumulation of ice or snow at any portion of a roof including edges of the roof. This prevents damage to interior portions within the home as well as prevent dangerous accumulation of snow that may fall down and injure a person. Still further, because of the placement of the one or more unsecured metal plates 106-1, 106-2, 108-1, 108-2 between the first secured metal plate 104-1, 104-2 and the second secured metal plate 110-1, 110-2 thereby forming a metal plate cartridge 102-1, 102-2, the roof-installed heat cable system 100 may be made accessible to a maintenance worker, technician, or homeowner. Because the heat cable 112 is formed between the one or more unsecured metal plates 106-1, 106-2, 108-1, 108-2 and each of the first secured metal plate 104-1, 104-2 and second secured metal plate 110-1, 110-2, the removal of the one or more unsecured metal plates 106-1, 106-2, 108-1, 108-2 allows the maintenance worker, technician, or homeowner to access the heat cable 112 by removing only the unsecured metal plates 106-1, 106-2, 108-1, 108-2, remove the heat cable 112, and either repair the heat cable 112 or replace the heat cable 112. After the heat cable 112 is replaced, each of the sets of one or more unsecured metal plates 106-1, 106-2, 108-1, 108-2 may be used to, again, push and sandwich the heat cable 112 between the one or more unsecured metal plates 106-1, 106-2, 108-1, 108-2 and each of the first secured metal plate 104-1, 104-2 and second secured metal plate 110-1, 110-2. Therefore, by simply removing the removable edge plate (that also operates as an environmental barrier to the roof-installed heat cable system 100), the maintenance worker, technician, or homeowner may easily replace the heat cable 112 if and when the heat cable 112 has failed to produce heat and sufficiently heat each of the one or more unsecured metal plates 106-1, 106-2, 108-1, 108-2, first secured metal plate 104-1, 104-2, and second secured metal plate 110-1, 110-2 in order to heat the roof.

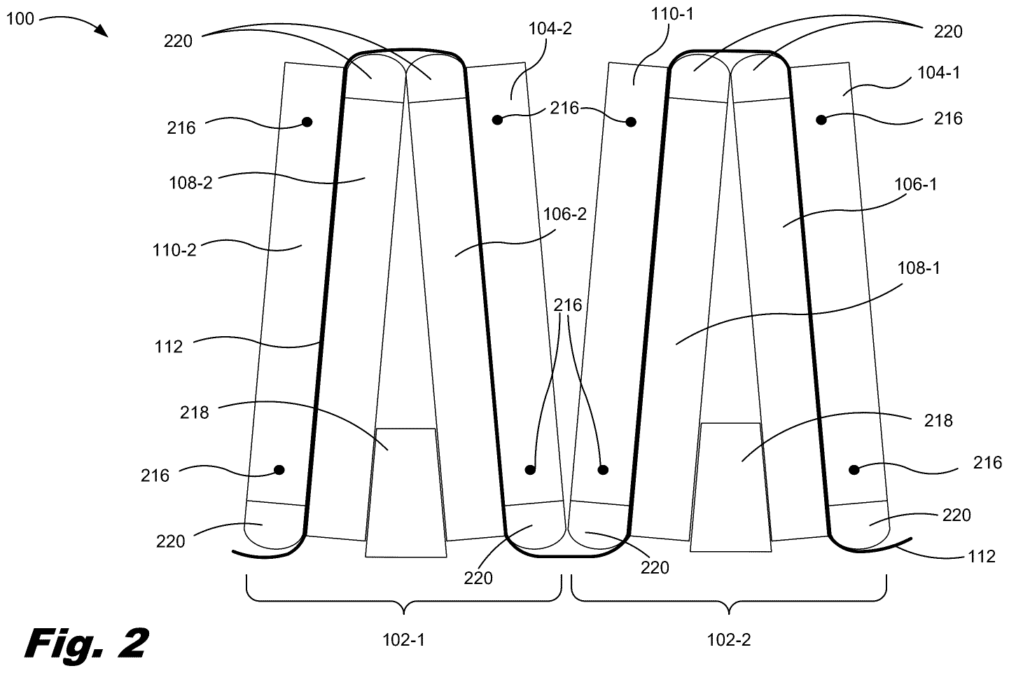

FIG. 2 is a graphic top view diagram illustrating two of a plurality of cartridges 102-1, 102-2 within a roof-installed heat cable system 100 comprising a plurality of secured metal plates 104-1, 104-2, 110-1, 110-2, a plurality of unsecured metal plates 106-1, 106-2, 180-1, 108-2, and a heat cable 112 according to an embodiment of the present disclosure. As described herein, the roof-installed heat cable system 100 may be formed anywhere under a roofing material (e.g., metal SSMR roofing material) on a roof and, in an embodiment, along an edge of the roof.

As shown in FIG. 2, a first secured metal plate 104-1 of a first cartridge 102-1 may be secured to a sub-level decking surface of a roof that is recessed below a primary roof decking. The first secured metal plate 104-1 and any other secured metal plate 104-1, 110-1, 110-2 may be secured to this sub-level decking surface via one or more metal plate fasteners 216. These metal plate fasteners 216 may include screws, nails, and the like that fixes these first secured metal plates 104-1, 104-2 and second secured metal plates 110-1, 110-2 to the sub-level decking surface.

As shown in FIG. 2, the first secured metal plate 104-1 of the first cartridge 102-1 may be placed at a distance from the second secured metal plate 110-1 of the first cartridge 102-1 sufficient to, at least, allow for the first unsecured metal plate 106-1 and second unsecured metal plate 108-1 to be placed in between them. As described in connection with FIG. 1, the heat cable 112 may be passed in between the first secured metal plate 104-1 and first unsecured metal plate 106-1 of the first cartridge 102-1 and down between the second unsecured metal plate 108-1 and the second secured metal plate 110-1. Because a left side of the first secured metal plate 104-1 includes a cable-receiving groove and the right side of the of the first unsecured metal plate 106-1 includes a complementary or matching cable-receiving groove, the heat cable 112 may be sandwiched in between these two metal plates such that heat energy produced by the heat cable 112 may be transferred into the first secured metal plate 104-1 and first unsecured metal plate 106-1 via thermal conduction. This allows the heat cable 112 to heat these two metal plates such that the entire surface of the first secured metal plate 104-1 and first unsecured metal plate 106-1 may transfer heat into the metal roofing material of the SSMR roofing and melt any accumulated ice or snow.

Similarly, the heat cable 112 may be passed between the second unsecured metal plate 108-1 and second secured metal plate 110-1. In this embodiment, the left side of the second unsecured metal plate 108-1 may include the cable-receiving groove and the right side of the second secured metal plate 110-1, 110-2 may include a complementary or matching cable-receiving groove. Similar to the other set of metal plates, this creates a channel through which the heat cable 112 may be passed. As the heat cable 112 is heated, heat is passed into the second unsecured metal plate 108-1 and second secured metal plate 110-1 via thermal conduction such that the entire surface of the second unsecured metal plate 108-1 and second secured metal plate 110-1 may transfer heat into the metal roofing material of the SSMR roofing and melt any accumulated ice or snow.

FIG. 2 also shows the heat cable 112 passing from the first cartridge 102-1 to the second cartridge 102-2. The second cartridge 102-2 may also include its own set of metal plates. As described, the second cartridge 102-2 includes a first secured metal plate 104-2 and a first unsecured metal plate 106-2 that each include complementary cable-receiving grooves to allow the heat cable 112 to, once again, pass upward. The heat cable 112 may also be passed down between the second unsecured metal plate 108-2 and second secured metal plate 110-2 with the cable-receiving grooves formed in the sides of the second unsecured metal plate 108-2 and second secured metal plate 110-2 forming a channel through which the heat cable 112 may pass. Similar to the first cartridge 102-1, the heat cable 112 may heat each of the first secured metal plate 104-2, first unsecured metal plate 106-2, second unsecured metal plate 108-2, and second secured metal plate 110-2 of the second cartridge 102-2 to heat a portion of the metal roofing material of the SSMR roofing next to the first cartridge 102-1. By placing subsequent cartridges 102-1, 102-2 alongside each other on an edge of the roof, an entire edge of a roof may be heated, and ice dams may be prevented from forming.

Additionally, as shown in FIG. 2, the heat cable 112 may serpentine between the first secured metal plates 104-1, 104-2, first unsecured metal plates 106-1, 106-2, second unsecured metal plates 108-1, 108-2, and second secured metal plates 110-1, 110-2 of the first cartridge 102-1 and second cartridge 102-2 such that heat may be passed into a pair of metal plates via thermal conduction. In order to prevent damage to the heat cable 112, each of the metal plates 104-1 through 110-2 may include an end cap 220 (also referred to herein as a rounded end cap). This end cap 220 may be press fitted into a terminal end of each of the metal plates 104-1 through 110-2. Each of the end caps 220 may, in an embodiment, be made of plastic such that the heat cable 112 may pass smoothly across the surface of the end caps 220. For example, during installation of the roof-installed heat cable system 100 and after the first secured metal plates 104-1, 104-2 and second secured metal plates 110-1, 110-2 are secured to the sub-level decking surface, the first unsecured metal plates 106-1, 106-2 and second unsecured metal plates 108-1, 108-2 may be pushed upwards, towing the heat cable 112 up and into position as shown in FIG. 2. The end caps 220 of these unsecured metal plates 106-1, 106-2, 108-1, 108-2 may prevent the heat cable 112 from rubbing against a metal surface of the metal plates thereby preventing damage to the heat cable during installation and maintenance of the roof-installed heat cable system 100.

In order to secure the first unsecured metal plates 106-1, 106-2 to their respective first secured metal plates 104-1, 104-2 and the second unsecured metal plates 108-1, 108-2 to their respective second secured metal plates 110-1, 110-2, the roof-installed heat cable system 100 may further include a metal plate wedge 218. This metal plate wedge 218 may be placed between the first unsecured metal plate 106-1, 106-2 and the second unsecured metal plate 108-1, 108-2 of each cartridge 102-1, 102-2 such that these unsecured metal plates 106-1, 106-2, 108-1, 108-2 are pressed against the secured metal plates 104-1, 104-2, 110-1, 110-2. This metal plate wedge 218 secures these unsecured metal plates 106-1, 106-2, 108-1, 108-2 in place until a maintenance worker, technician, or the homeowner needs to repair the roof-installed heat cable system 100. Maintenance may begin with the maintenance worker, technician, or homeowner removing the metal plate wedge 218 such that the unsecured metal plates 106-1, 106-2, 108-1, 108-2 are no longer pressed against the second secured metal plates 110-1, 110-2. This allows the maintenance worker, technician, or homeowner to remove the unsecured metal plates 106-1, 106-2, 108-1, 108-2 which, in turn, allows access to the heat cable 112. Because the first secured metal plates 104-1, 104-2 and second secured metal plates 110-1, 110-2 remain fixed to the sub-level decking surface, the replacement of the heat cable 112 and unsecured metal plates 106-1, 106-2, 108-1, 108-2 may be easily accomplished with the heat cable 112 and unsecured metal plates 106-1, 106-2, 108-1, 108-2 being returned to their previous locations and once again wedged against the respective first secured metal plate 104-1, 104-2 and second secured metal plate 110-1, 110-2 via the placement of the metal plate wedge 218.

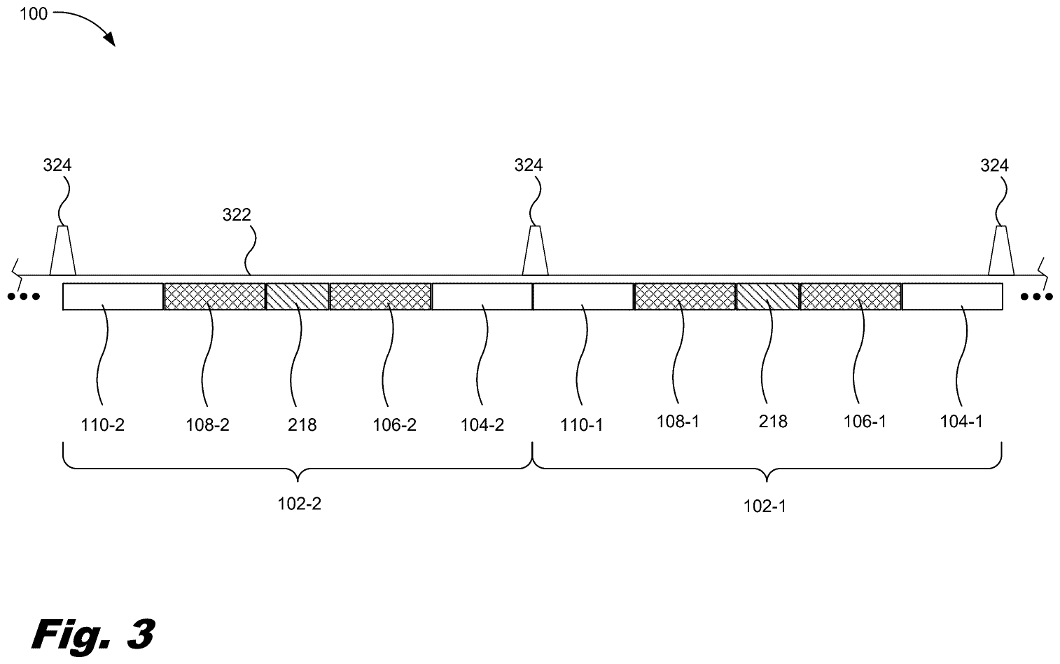

FIG. 3 is a side block diagram illustrating two of a plurality of cartridges 102-1, 102-2 within a roof-installed heat cable system 100 comprising a plurality of secured metal plates 104-1, 104-2, 110-1, 110-2 and a plurality of unsecured metal plates 106-1, 106-2, 108-1, 108-2 formed under a roofing material such as a metal roofing material 322 according to an embodiment of the present disclosure.

In an embodiment, this lateral view of the cartridges 102-1, 102-2 may be seen by a maintenance worker, technician, or homeowner when maintaining the roof-installed heat cable system 100. This view shows the first cartridge 102-1 and second cartridge 102-2 placed under a metal roofing material 322 which may include SSMR roofing that includes a plurality of standing seams 324. These standing seams 324 may be used to manage water on the roof, prevents water ingress, allows for thermal expansion of the metal SSMR roofing material, and provides protection against the elements. In an embodiment, the standing seams 324 may be placed at specific locations between each cartridge 102-1, 102-2 such that the metal roofing material 322 may be secured to a metal plate via a roofing fastener that passes through the metal roofing material 322 and into one of the metal plates 104-1 through 110-2. Thus, in an embodiment, the individual metal sheets of the SSMR roofing material may be secured to the roof and the metal plates while the standing seams 324 may be mated with interlocking profiles of a subsequent metal sheet of the SSMR roofing material. In an embodiment, the metal of the metal plates 104-1 through 110-2 may be soft enough for these roofing material fasteners to pass into in order to secure the SSMR roofing material to the roof. In a specific embodiment, because the unsecured metal plates 106-1, 106-2, 108-1, 108-2 are to be removed from the roof-installed heat cable system 100 during maintenance, the fastening seam of the individual metal sheets of the SSMR roofing material may be placed over the secured metal plates 104-1, 104-2, 110-1, 110-2 that are not to be removed during this maintenance process.

The layout of the metal plates 104-1 through 110-2 may be similar to that shown in FIG. 2. FIG. 3 does not show the heat cable 112, however, the heat cable may serpentine among the various metal plates 104-1 through 110-2 as shown in FIG. 2. During maintenance, the maintenance worker, technician, or homeowner may first remove each metal plate wedge 218 within each cartridge 102-1, 102-2. This allows the maintenance worker, technician, or homeowner to then remove the unsecured metal plates 106-1, 106-2, 108-1, 108-2 and the heat cable 112 in order to repair or replace the heat cable 112. When installing the repaired or new heat cable 112, the reverse steps may be accomplished. In an embodiment, the maintenance worker, technician, or homeowner may place the heat cable 112 within the void where the unsecured metal plates 106-1, 106-2, 108-1, 108-2 formerly were located. The heat cable 112 may then be forced into the void using the unsecured metal plates 106-1, 106-2, 108-1, 108-2 with their respective end caps (not shown) preventing damage to the repaired or new heat cable 112. When the unsecured metal plates 106-1, 106-2, 108-1, 108-2 are arranged in their previous locations within each cartridge 102-1, 102-2, the metal plate wedge 218 may be replaced. It is appreciated that as the metal plate wedge 218 is replaced, the unsecured metal plates 106-1, 106-2, 108-1, 108-2 are forced against respective secured metal plates 104-1, 104-2, 110-1, 110-2. This sandwiches the heat cable 112 into the cable-receiving grooves formed on the sides of the metal plates 104-1 through 110-2 so that heat can be transferred into the metal plates 104-1 through 110-2 in order to heat the roof.

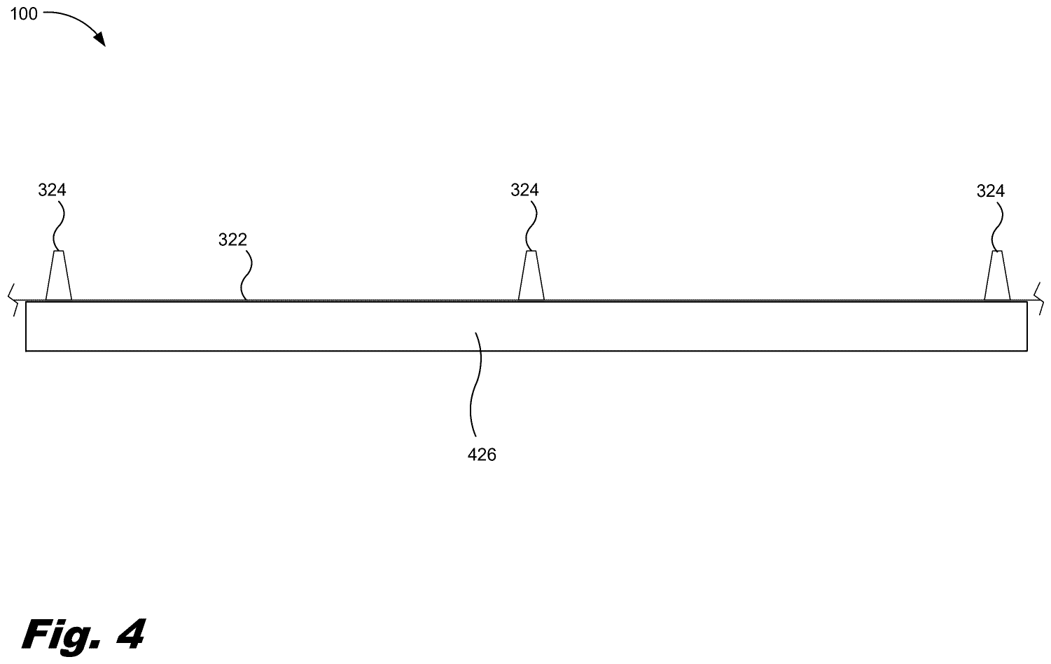

FIG. 4 is a side block diagram illustrating a removable edge plate covering the cartridges within a roof-installed heat cable system 100 shown in FIG. 3 according to an embodiment of the present disclosure. As described in FIG. 3, the roof-installed heat cable system 100 may be formed under a metal roofing material 322 such as an SSMR roofing material that includes standing seams 324 that align the sheets of metal roofing material 322 with one or more first secured metal plates 104-1, 104-2 and/or second secured metal plates 110-1, 110-2.

In order to prevent incursion of water and moisture below the metal roofing material 322, a removable edge plate 426 may be coupled to, at least, a facia plate of the roof. In an embodiment, the removable edge plate 426 may be made of aluminum or other metal such as the metal used for the metal roofing material 322. A number of removable edge plate fasteners may be used to secure the removable edge plate 426 to the facia of the roof. In an embodiment, the removable edge plate 426 may be coupled to an edge of the metal roofing material 322 via a hem formed in the metal roofing material 322. An edge of the removable edge plate 426 may be slipped into this hem and secured to the facia of the roof. Alternatively, a dedicated drip plate may be used under the metal roofing material 322 for the removable edge plate 426 to interface with using a similar hem formed in the dedicated drip plate.

In order to gain access to the roof-installed heat cable system 100, the maintenance worker, technician, or homeowner may first remove the removable edge plate fasteners from the removable edge plate 426. These removable edge plate fasteners may be retained for reinstalment later. The maintenance worker, technician, or homeowner may then slip the removable edge plate 426 from the hem formed in the metal roofing material 322 or dedicated drip plate. This allows the maintenance worker, technician, or homeowner to gain access to the roof-installed heat cable system 100, perform the maintenance as described herein, and reinstall the removable edge plate 426 by slipping the removable edge plate 426 into the hem created at the metal roofing material 322 or dedicated drip plate.

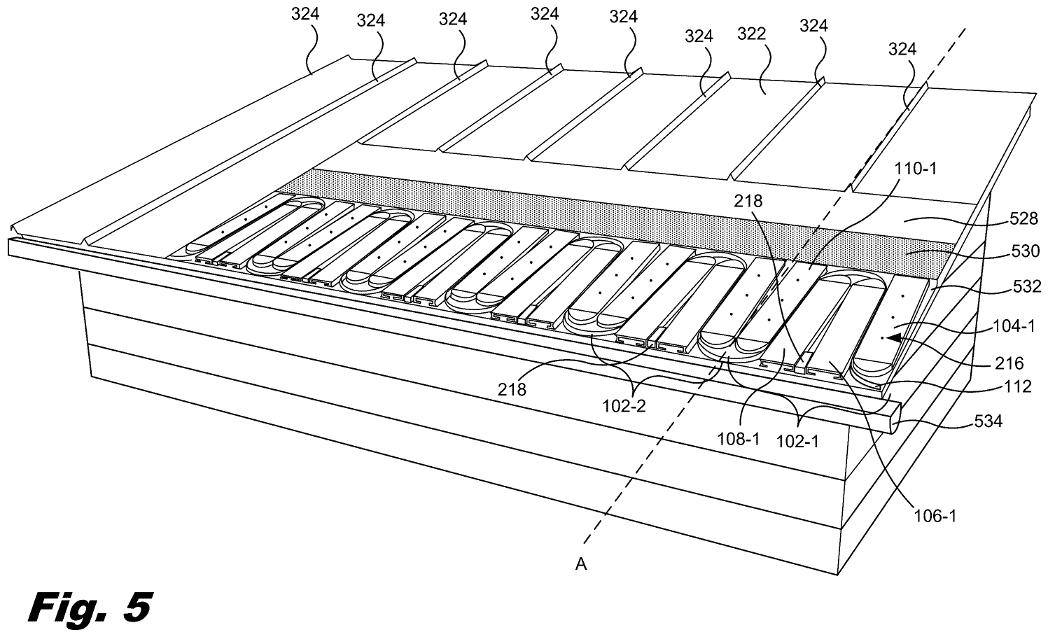

FIG. 5 is a perspective graphical diagram illustrating a roof-installed heat cable system 100 as installed with a heat cable 112 on a roof according to an embodiment of the present disclosure. The roof-installed heat cable system 100 shown in FIG. 5 shows more than two cartridges 102-1, 102-2 with a first cartridge 102-1 and a second cartridge 102-2 being called out individually. These cartridges 102-1, 102-2 are formed along an entire length of an edge of a roof. It is appreciated that the number of cartridges 102-1, 102-2 used along the edge of the roof may vary depending on the length of the roof or the length of the roof that needs to be heated using the roof-installed heat cable system 100. It is also appreciated that the location and placement of the roof-installed heat cable system 100 may vary depending on anticipated locations on the roof where ice or snow may accumulate.

Similar to FIGS. 1 and 2, for example, each cartridge 102-1, 102-2 includes a first secured plate 104-1, 104-2. Again, the first secured plate 104-1, 104-2 may be secured to the roof using a plurality of metal plate fasteners 216. FIG. 5 shows that the first secured plates 104-1, 104-2, as well as the second secured plates 110-1, 110-2, may be secured at different angles relative to an edge of the roof. This angle may be slight such that the unsecured metal plates 106-1, 106-2, 108-1, 108-2 may be disposed into the cavity and wedged against he first secured plate 104-1, 104-2 and second secured plates 110-1, 110-2 using the metal plate wedges 218 as described herein.

FIG. 5 also shows the heat cable 112 passing in between the secured metal plates 104-1, 104-2, 110-1, 110-2 in a serpentine fashion. This allows the heat produced by the heat cable 112 to be in contact with each of the metal plates 104-1 through 110-2 to, through thermal conduction, transfer the heat to the metal plates 104-1 through 110-2. This heat is then transferred, via thermal conductivity, from the metal plates 104-1 through 110-2 to the metal roofing material 322. Again, this prevents the accumulation of ice or snow at, in the example embodiment shown in FIG. 5, the edge of the roof.

FIG. 5 shows certain layers that form a completed roof that covers a top portion of the roof-installed heat cable system 100. Portions of these layers have been removed in FIG. 5 to show the other layers as well as the installed roof-installed heat cable system 100. In an example, the roof may include a sub-level decking surface 532 that is formed in a recessed portion of the primary roof decking surface 530. In an embodiment, this sub-level decking surface 532 may have a depth that is at least as deep as the height of the metal plates 104-1 through 110-2 of the roof-installed heat cable system 100. This allows the metal plates 104-1 through 110-2 to sit within this sub-level decking surface 532. As shown in FIG. 5, the length of the sub-level decking surface 532 may be sufficient to allow the metal plates 104-1 through 110-2 to fit therein such that the metal plates 104-1 through 110-2 do not extend past an edge of the roof. Both the primary roof decking surface 530 and the sub-level decking surface 532 may be made of common roof decking materials such as CDX plywood or oriented strand board (OSD) and the like.

I an embodiment, the layers of the roof may also include an underlayment layer 528. This underlayment layer 528 may be installed between the primary roof decking surface 530/sub-level decking surface 532 and the metal roofing material 322. In an embodiment, the underlayment layer 528 may be a protective sheet that provides an extra barrier against moisture, wind, and other environmental elements. In an embodiment, the underlayment layer 528 may be made of a peel-and-stick membrane that includes asphalt-saturated felt or plastic polymers such as polypropylene or polyethylene. Although FIG. 5 shows that the underlayment layer 528 only extends down the roof a certain distance, this is meant to only show the primary roof decking surface 530 and, in some embodiments, the underlayment layer 528 may extend as far down the slop of the roof as the metal roofing material 322 extends and may be used to cover the roof-installed heat cable system 100.

As described herein, the metal roofing material 322 may include SSMR roofing that includes a plurality of standing seams 324. These standing seams 324 may be used to manage water on the roof, prevents water ingress, allows for thermal expansion of the metal SSMR roofing material, and provides protection against the elements. In an embodiment, the standing seams 324 may be placed at specific locations between each cartridge 102-1, 102-2 such that the metal roofing material 322 may be secured to a metal plate via a roofing fastener that passes through the metal roofing material 322 and into one of the metal plates 104-1 through 110-2. Thus, in an embodiment, the individual metal sheets of the SSMR roofing material may be secured to the roof and the metal plates while the standing seams 324 may be mated with interlocking profiles of a subsequent metal sheet of the SSMR roofing material. Line “A” shows that the standing seam 324 is situated to pass in between secured metal plates 104-1, 104-2, 110-1, 110-2 such that roofing fasteners may be passed through the metal roofing material 322 and into the secured metal plates 104-1, 104-2, 110-1, 110-2 at those seams between the individual metal sheets of metal roofing material 322. In an embodiment, the metal of the metal plates 104-1 through 110-2 may be soft enough for these roofing material fasteners to pass into in order to secure the SSMR roofing material to the roof. In a specific embodiment, because the unsecured metal plates 106-1, 106-2, 108-1, 108-2 are to be removed from the roof-installed heat cable system 100 during maintenance, the fastening seam of the individual metal sheets of the SSMR roofing material may be placed over the secured metal plates 110-1, 110-2 that are not to be removed during this maintenance process.

The layout of the metal plates 104-1 through 110-2 may be similar to that shown in FIG. 2. In FIG. 5, the heat cable 112 may serpentine among the various metal plates 104-1 through 110-2. During maintenance, the maintenance worker, technician, or homeowner may first remove each metal plate wedge 218 within each cartridge 102-1, 102-2. This allows the maintenance worker, technician, or homeowner to then remove the unsecured metal plates 106-1, 106-2, 108-1, 108-2 and the heat cable 112 in order to repair or replace the heat cable 112. When installing the repaired or new heat cable 112, the reverse steps may be accomplished. In an embodiment, the maintenance worker, technician, or homeowner may place the heat cable 112 within the void where the unsecured metal plates 106-1, 106-2, 108-1, 108-2 formerly were located. The heat cable 112 may then be forced into the void using the unsecured metal plates 106-1, 106-2, 108-1, 108-2 with their respective end caps (not shown) preventing damage to the repaired or new heat cable 112. When the unsecured metal plates 106-1, 106-2, 108-1, 108-2 are arranged in their previous locations within each cartridge 102-1, 102-2, the metal plate wedge 218 may be replaced. It is appreciated that as the metal plate wedge 218 is replaced, the unsecured metal plates 106-1, 106-2, 108-1, 108-2 are forced against respective secured metal plates 104-1, 104-2, 110-1, 110-2. This sandwiches the heat cable 112 into the cable-receiving grooves formed on the sides of the metal plates 104-1 through 110-2 so that heat can be transferred into the metal plates 104-1 through 110-2 in order to heat the roof.

As described a removable edge plate (not shown in FIG. 5) may be placed along a lateral edge of the roof to conceal the roof-installed heat cable system 100 and prevent moisture from entering underneath the roof. Additionally, the roof-installed heat cable system 100 may be installed with those roofs that also include a roof gutter system 534. Indeed, even with the inclusion of the roof gutter system 534, the roof-installed heat cable system 100 may still be accessed laterally along the edge of the roof via removal of the removable edge plate as described herein.

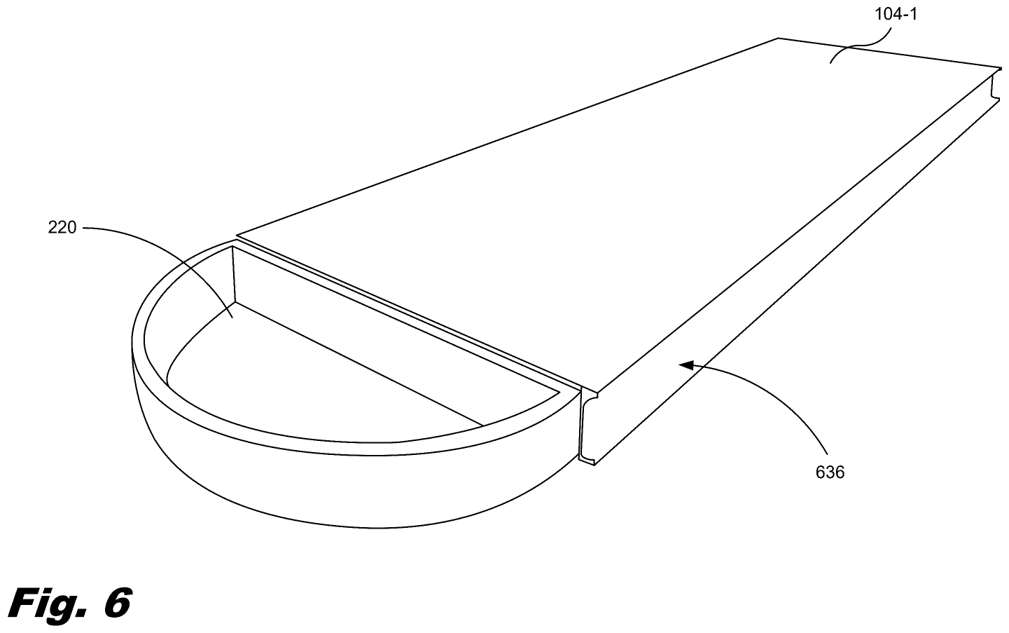

FIG. 6 is perspective view, graphical diagram illustrating a metal plate (e.g., 104-1, FIG. 2) used as a secured metal plate (e.g., 104-1, 104-2, 110-1, 110-2, FIG. 1) or unsecured metal plate (e.g., 106-1, 106-2, 108-1, 108-2, FIG. 1) of the roof-installed heat cable system (e.g., 100, FIG. 1) according to an embodiment of the present disclosure. a first secured metal plate 104-1 is used herein as an example metal plate in FIG. 6. It is appreciated that each of the secured metal plates and unsecured metal plates may be of similar shape and form with the difference between the secured metal plates and the unsecured metal plates being that the secured metal plates include metal plate fasteners (e.g., 216, FIG. 2) used to secure the secured metal plates to a sub-level decking surface.

As described herein, each of the metal plates 104-1 may include an end cap 220. This end cap 220 may be press fitted into a terminal end of each of the metal plates 104-1 through 110-2. Each of the end caps 220 may, in an embodiment, be made of plastic such that the heat cable (not shown) may pass smoothly across the surface of the end caps 220. For example, during installation of the roof-installed heat cable system and after the first secured metal plates and second secured metal plates are secured to the sub-level decking surface, the first unsecured metal plates and second unsecured metal plates may be pushed upwards, towing the heat cable up and into position as shown in, for example, FIG. 2. The end caps 220 of these unsecured metal plates and the metal plate 104-1 shown in FIG. 6 may prevent the heat cable from rubbing against a metal surface of the metal plates thereby preventing damage to the heat cable during installation and maintenance of the roof-installed heat cable system.

Again, as described herein, the metal plate 104-1 may include a cable-receiving groove 636 formed on one side of the metal plate 104-1. This cable-receiving groove 636 may be formed to receive or house a portion of the heat cable. As described herein, the cable-receiving groove 636 may be formed on a side surface of each of the metal plates 104-1 such that two of the metal plates 104-1 may align and form channels between those metal plates 104-1. In an embodiment, the formed channel may entirely circumvent or surround the heat cable such that the entire outer surface of the heat cable is in physical contact with two metal plates 104-1 thereby distributing the heat from the heat cable touching the metal plates 104-1 into those metal plates 104-1. It is appreciated that, in some example embodiments, the entire outer surface of the heat cable that is sandwiched between two of the metal plates 104-1 and placed within the formed channel may not be in physical contact with the metal plates 104-1. Although this reduced or limited physical contact between the metal plates 104-1 and heat cable may be present in the roof-installed heat cable system, heat may still be distributed into the metal plates 104-1 and is still sufficient to heat the metal roof and prevent ice dams from forming.

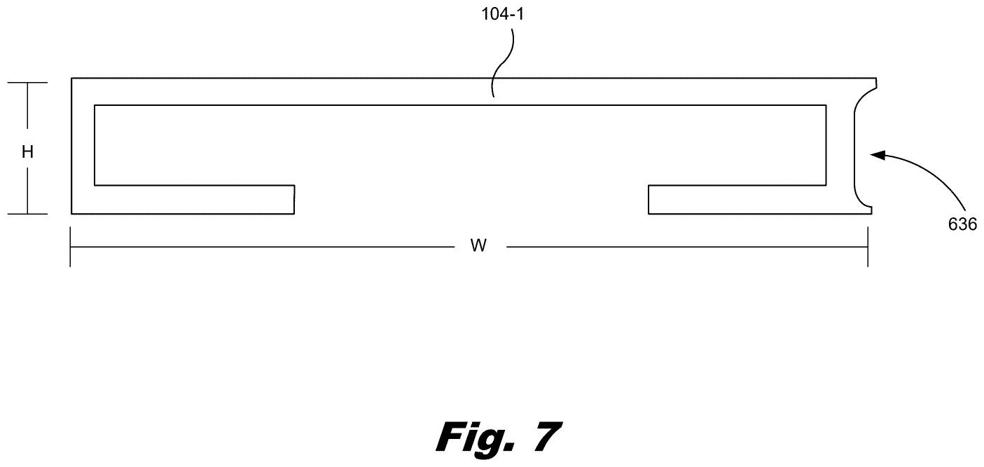

FIG. 7 is a side view, graphical diagram illustrating a metal plate 104-1 used as a secured or unsecured metal plate of the roof-installed heat cable system according to an embodiment of the present disclosure. Similar to FIG. 6, FIG. 7 shows a single metal plate 104-1 as an example and the metal plate 104-1 may be used as any of a secured or unsecured metal plate within the roof-installed heat cable system.

In an embodiment, the metal plates 104-1 may have uniform dimensions such that the metal plates 104-1 may fit within the sub-level decking surface (e.g., 532, FIG. 5) formed into the roof. In an embodiment, a height “H” of the metal plate 104-1 may be between 0.25 in and 0.75 in. In an embodiment, the height “H” of the metal plate 104-1 may be 0.625 in. Again, the height “H” of the metal plate 104-1 may be uniform across all metal plates such that each will fit within the sub-level decking surface and may come in contact with the metal roofing material. In an embodiment, the width “W” of the metal plate 104-1 may be between 3.75 in and 3.25 in. In an embodiment, the width “W” of the metal plate 104-1 may be 3.587 in. As described herein, a length of the metal plates 104-1 may be varied depending on the distance from an edge of a roof that is to be heated by the roof-installed heat cable system. In an embodiment, the length of the metal plates 104-1 may be selected based on the pitch of the roof, the anticipated accumulation of ice and snow at the edge of the roof, the heating capabilities of the heat cable, and the type of roofing material used, among other factors.

FIG. 7 also shows the cable-receiving groove 636 as described in connection with FIG. 6. However, FIG. 7 shows a cross-section view of an example cable-receiving groove 636 that may fit, for example, an oblong or oval cross-sectional heat cable. Again, two of the metal plates 104-1 may be aligned with each other with their respective cable-receiving grooves 636 facing each other in order to form channels between those metal plates 104-1. In an embodiment, the formed channel may entirely circumvent or surround the heat cable such that the entire outer surface of the heat cable is in physical contact with two metal plates 104-1 thereby distributing the heat from the heat cable touching the metal plates 104-1 into those metal plates 104-1. It is appreciated that, in some example embodiments, the entire outer surface of the heat cable that is sandwiched between two of the metal plates 104-1 may not be in physical contact with the metal plates 104-1. Although this reduced or limited physical contact between the metal plates 104-1 and heat cable may be present in the roof-installed heat cable system, heat may still be distributed into the metal plates 104-1 and is still sufficient to heat the metal roof and prevent ice dams from forming.

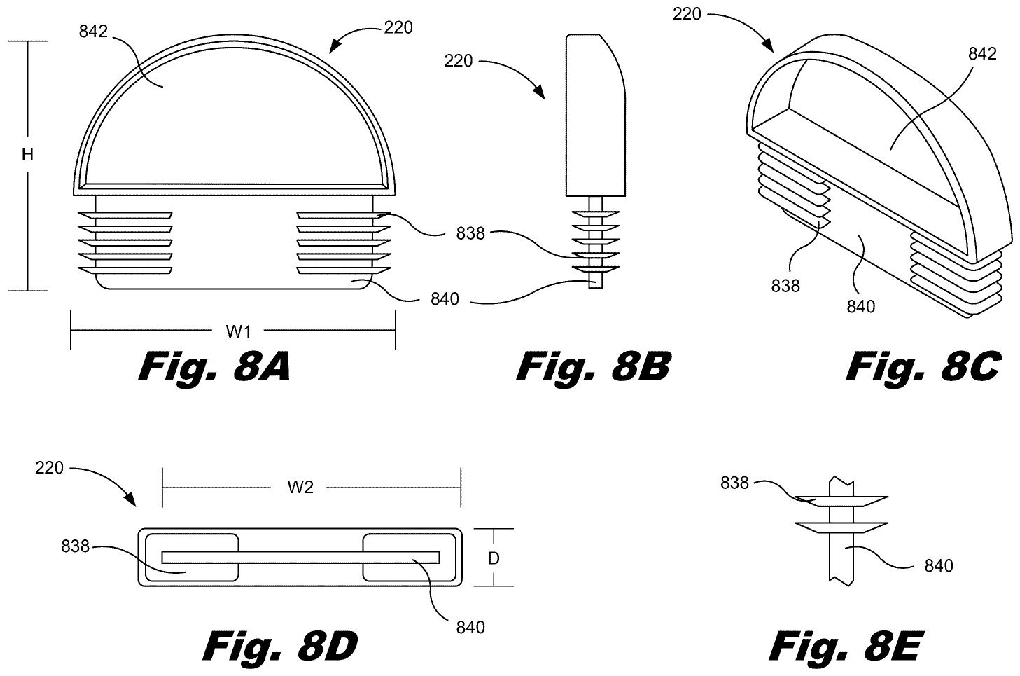

FIGS. 8A through 8E show various views of an end cap 220 that may be press fitted into the terminal ends of the metal plates as shown in FIG. 6, for example. FIG. 8A is a front a graphical diagram of a rounded end cap 220 operatively couplable to a secured or unsecured metal plate of the roof-installed heat cable system according to an embodiment of the present disclosure. Additionally, FIG. 8B is a side graphical diagram of a rounded end cap 220 operatively couplable to a secured or unsecured metal plate of the roof-installed heat cable system according to an embodiment of the present disclosure. Further, FIG. 8C is a front perspective view graphical diagram of a rounded end cap 220 operatively couplable to a secured or unsecured metal plate of the roof-installed heat cable system according to an embodiment of the present disclosure. Still further, FIG. 8D is a bottom graphical diagram of a rounded end cap 220 operatively couplable to a secured or unsecured metal plate of the roof-installed heat cable system according to an embodiment of the present disclosure. Additionally, FIG. 8E is a side view graphical diagram of securement fins 838 of a rounded end cap 220 operatively couplable to a secured or unsecured metal plate of the roof-installed heat cable system according to an embodiment of the present disclosure.

As described herein, the rounded end cap 220 may, in an embodiment, be made of plastic such that the heat cable may pass smoothly across the surface of the end caps 220. For example, during installation of the roof-installed heat cable system and after the first secured metal plates and second secured metal plates are secured to the sub-level decking surface, the first unsecured metal plates and second unsecured metal plates may be pushed upwards, towing the heat cable up and into position as shown in FIG. 2, for example. The end caps 220 of these unsecured metal plates and of the secure metal plats may prevent the heat cable from rubbing against a metal surface of the metal plates thereby preventing damage to the heat cable during installation and maintenance of the roof-installed heat cable system.

In an embodiment, an overall width “W1” of the rounded end cap 220 may be sufficient to guide the heat cable away from the sharp metallic edges of the metal plates described herein. In an embodiment, the overall width “W1” of the rounded end cap 220 may be between 3.50 in and 3.20 in. In an embodiment, the overall width “W1” of the rounded end cap 220 may be 3.375 in. The height “H” of the rounded end cap 220 may be such that the overall length of the combined rounded end cap 220 and metal plate fits within the sub-level decking surface (e.g., 532, FIG. 5) of the roof. As such, because the height “H” of the rounded end cap 220 cannot be readily changed during installation of the roof-installed heat cable system, the length of the metal plates may be altered to accommodate for the height of the rounded end cap 220. In an embodiment, the height “H” of the rounded end cap 220 may be between 3 in and 2 in. In an embodiment, the height “H” of the rounded end cap 220 may be 2.751 in. The depth “D” of the rounded end cap 220 may also be sufficient to not extend past the height “H” of the metal plate as shown in FIG. 7 thereby not extending upwards against the bottom surface of the metal roofing material when installed. In an embodiment, the depth “D” of the rounded end cap 220, as shown in FIG. 8D for example, may be between 0.25 in and 0.75 in. In an embodiment, the depth “D” of the rounded end cap 220 may be 0.625 in.

The rounded end cap 220 may include a gripping portion 842 where a user may grip and handle the metal plates for case of installment. Additionally, the rounded end cap 220 may include an end cap stanchion 840. The end cap stanchion 840 may extends away from the gripping portion 842 of the rounded end cap 220. This end cap stanchion 840 may have a second width “W2” that allows the end cap stanchion 840 to fit within a lateral cavity of the metal plates. As such, the second width “W2” of the end cap stanchion 840 may be between 4 in and 2 in. In an embodiment, the second width “W2” of the end cap stanchion 840 may be 3.0 in.

As shown in FIGS. 8A through 8D and specifically in a magnified view in 8E, the end cap stanchion 840 may have a plurality of securement fins 838 affixed to the end cap stanchion 840. The securement fins 838 may be a monolithic part of the end cap stanchion 840 and may be made of a thicker plastic layer towards the end cap stanchion 840 and may thin out the further the securement fins 838 extend away from the end cap stanchion 840. This thinning out of the securement fins 838 allows for some flexibility in the securement fins 838 such that as the rounded end cap 220 is press fitted into a terminal end of a metal plate, the securement fins 838 may bend. Additionally, when inserted into the terminal end of a metal plate, the securement fins 838 serve to prevent removal of the rounded end cap 220 by virtue of the securement fins 838 being flexible in a first direction but rather rigid in a second direction. As such, during installation of the roof-installed heat cable system, the installer may have a relatively easy time of inserting the rounded end caps 220 into the terminal ends of the metal plates, but will have a relatively more difficult time removing the rounded end caps 220 if and when needed.

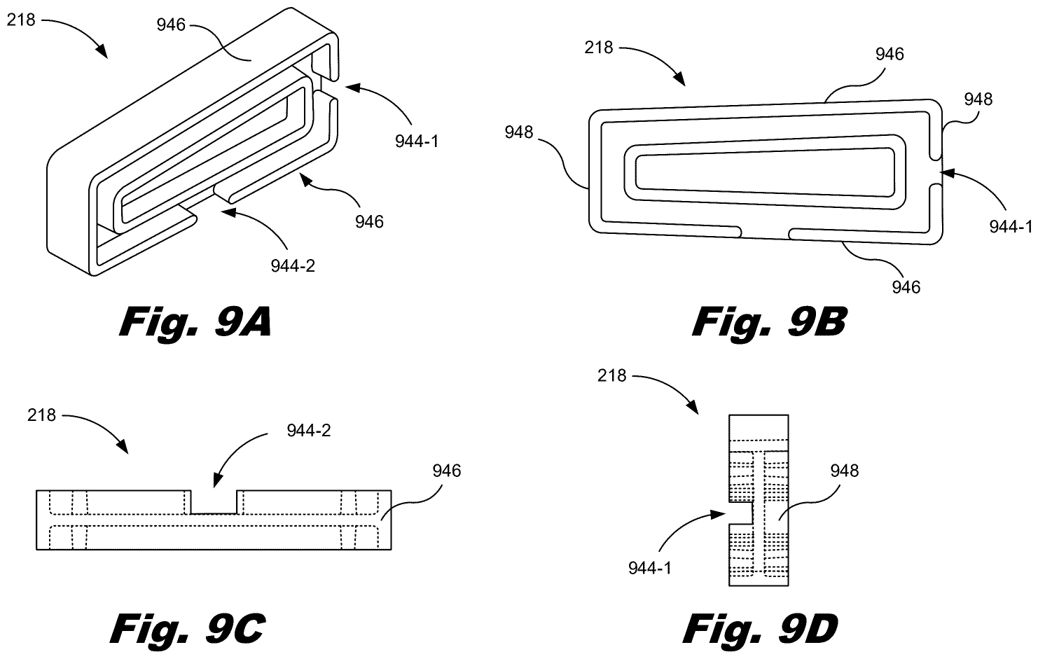

FIGS. 9A through 9D show various views of a metal plate wedge 218 used to wedge the various metal plates against each other during installation as described herein. FIG. 9A is a front, perspective view of a metal plate wedge 218 of the roof-installed heat cable system according to an embodiment of the present disclosure. Additionally, FIG. 9B is a front view of a metal plate wedge 218 of the roof-installed heat cable system according to an embodiment of the present disclosure. Further, FIG. 9C is a bottom view of a metal plate wedge 218 of the roof-installed heat cable system according to an embodiment of the present disclosure. Still further, FIG. 9D is a side view of a metal plate wedge 218 of the roof-installed heat cable system according to an embodiment of the present disclosure.

As described herein, in order to secure the first unsecured metal plates to their respective first secured metal plates and the second unsecured metal plates to their respective second secured metal plates, the roof-installed heat cable system may further include these metal plate wedges 218. This metal plate wedge 218 may be placed between the first unsecured metal plate and the second unsecured metal plate of each cartridge such that these unsecured metal plates are pressed against the secured metal plates. This metal plate wedge 218 secures these unsecured metal plates in place until a maintenance worker, technician, or the homeowner needs to repair the roof-installed heat cable system. Maintenance may begin with the maintenance worker, technician, or homeowner removing the metal plate wedge 218 such that the unsecured metal plates are no longer pressed against the second secured metal plates. In order to accomplish this removal, each of the metal plate wedges 218 may include a first removing via 944-1 and a second removing via 944-2 such that regardless of the orientation of the metal plate wedge 218, a maintenance worker may introduce a hook or other prodding instrument into the removing vias 944-1, 944-2 and pull the metal plate wedge 218 from in between the second unsecure metal plate and the first unsecured metal plate as described herein.

By removing the metal plate wedge 218 the maintenance worker, technician, or homeowner may then be able to remove the unsecured metal plates which, in turn, allows access to the heat cable. Because the first secured metal plates and second secured metal plates remain fixed to the sub-level decking surface, the replacement of the heat cable and unsecured metal plates may be easily accomplished with the heat cable and unsecured metal plates being returned to their previous locations and once again wedged against the respective first secured metal plate and second secured metal plate via the placement of the metal plate wedge 218.

As briefly mentioned, the metal plate wedge 218 may be oriented such that the metal plate wedge 218 may wedge in between the first unsecured metal plate and the second unsecured metal plate. Thus, in an embodiment, the metal plate wedge 218 may include a first pair of wedge surfaces 946 and a second pair of wedge surfaces 948. Therefore, in a first orientation of the metal plate wedge 218, the first pair of wedge surfaces 946 may contact the first unsecure metal plate and second unsecure metal plate in order to wedge these plates against their respective first secured metal plate and second secured metal plate. In a second orientation of the metal plate wedge 218, the second pair of wedge surfaces 948 may contact the first unsecure metal plate and second unsecure metal plate in order to wedge these plates against their respective first secured metal plate and second secured metal plate.

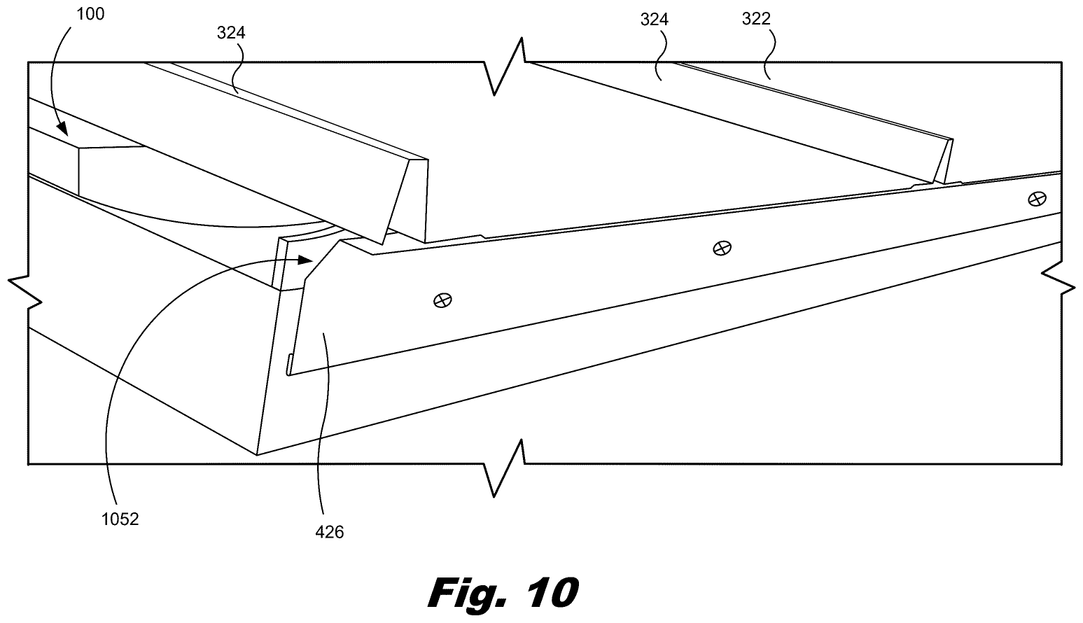

FIG. 10 is a perspective view of the roof-installed heat cable system 100 placed under a roofing material 322 and concealed using a removable edge plate 426 according to an embodiment of the present disclosure. Again, the roofing material may be a metal roofing material 322 that includes a plurality of standing seams 324. These standing seams 324 may be used to manage water on the roof, prevents water ingress, allows for thermal expansion of the metal SSMR roofing material, and provides protection against the elements. Also as described herein, the roof-installed heat cable system may be sealed off from the elements via the securement of a removable edge plate 426 laterally away from the roof-installed heat cable system and at the edge of the roof.

The removable edge plate 426 may be secured to a facia or other vertical surface of the roof using a plurality of removeable edge plate fasteners 1050. In an embodiment, the removeable edge plate fasteners 1050 may be screws that allow a maintenance worker, technician, or the homeowner toe easily remove the removeable edge plate fasteners 1050 in order to begin the process of servicing the roof-installed heat cable system as described herein.

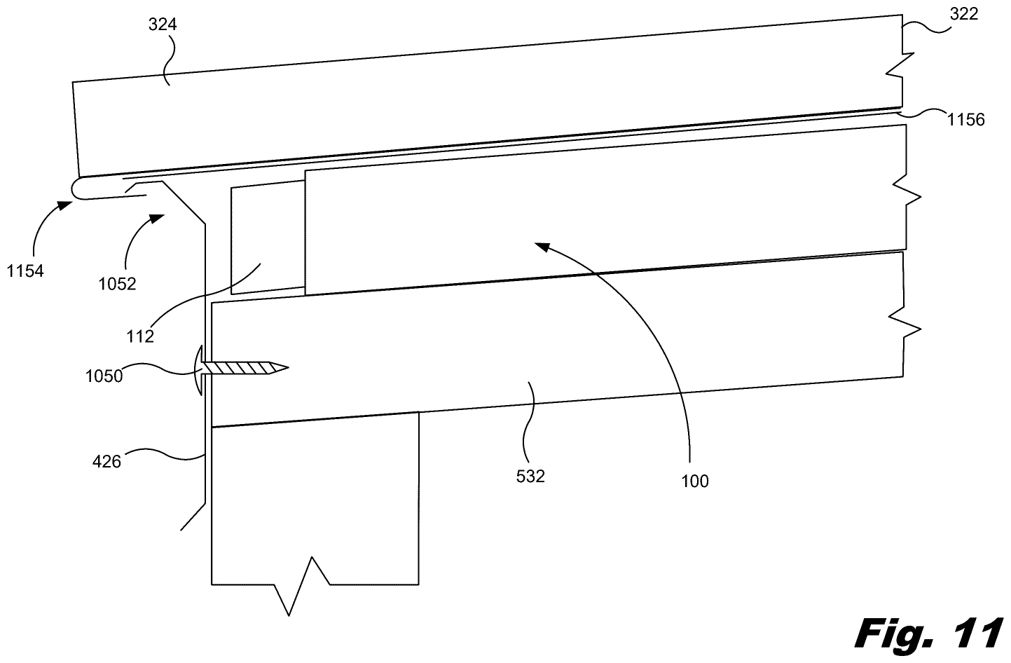

Also, in an embodiment, the removable edge plate 426 may be coupled to an edge of the metal roofing material 322 via a hem formed in the metal roofing material 322. An edge of the removable edge plate 426 may be slipped into this hem and secured to the facia of the roof using the removeable edge plate fasteners 1050. Alternatively, a dedicated drip plate may be used under the metal roofing material 322 for the removable edge plate 426 to interface with using a similar hem formed in the dedicated drip plate. To allow for ease of removal, the removable edge plate 426 may include an edge plate bending angle 1052. The edge plate bending angle 1052 may include an angled bend from the horizontal (or near horizontal) portion of the removable edge plate 426 to the vertical portion of the removable edge plate 426 such that the maintenance worker, technician, or homeowner may rotate the removable edge plate 426 out from the hem formed at the edge of the metal roofing material 322 or the drip plate as described herein. This feature may be more readily seen in FIG. 11.

FIG. 11 is a side, cross-sectional view of the roof-installed heat cable system 100 placed under a metal roofing material 322 and concealed using the removable edge plate 426 according to an embodiment of the present disclosure. This cross-sectional view shows the physical relationship between the sub-level decking surface 532, the roof-installed heat cable system 100, and the metal roofing material 322 as described herein.

Additionally, FIG. 11 shows the removable edge plate 426 being fastened to the roof (e.g., the sub-level decking surface 532) using removeable edge plate fasteners 1050 to secure it in place. Additionally, in the embodiment shown in FIG. 11, the roofing structure includes a drip plate 1156, also referred to herein as a cleat. The drip plate 1156 may be mounted on top of the plurality of cartridges (e.g., FIG. 5, 102-1, 102-2) and may be used to help support the metal roofing material 322 up to, at least, a terminal edge of the removable edge plate 426. In an embodiment, the drip plate 1156 may be secured to the plurality of cartridges (e.g., FIG. 5, 102-1, 102-2) using a fastener such as a nail similar to the method used to secure the metal roofing material 322 to the plurality of cartridges (e.g., FIG. 5, 102-1, 102-2) described herein. An edge of the metal roofing material 322 may also include a hem 1154 formed therein to engage with the removable edge plate 426 and the drip plate 1156 to help secure the edge of the metal roofing material 322 to the remaining portions of the roof-installed heat cable system 100 and to act as an edge where water can drip off of the roof. Indeed, FIG. 11 shows a top terminal edge of the removable edge plate 426 engaging with the hem 1154 formed into the metal roofing material 322. Again, the edge plate bending angle 1052 may include an angled bend from the horizontal (or near horizontal) portion of the removable edge plate 426 to the vertical portion of the removable edge plate 426 such that the maintenance worker, technician, or homeowner may rotate (e.g., clockwise direction as seen in FIG. 11) the removable edge plate 426 out from the hem 1154 formed at the edge of the metal roofing material 322 or the drip plate 1156 in order to gain access to the roof-installed heat cable system 100 for repair, maintenance, or replacement of any portion of the roof-installed heat cable system 100 such as the heat cable 112 as described herein.

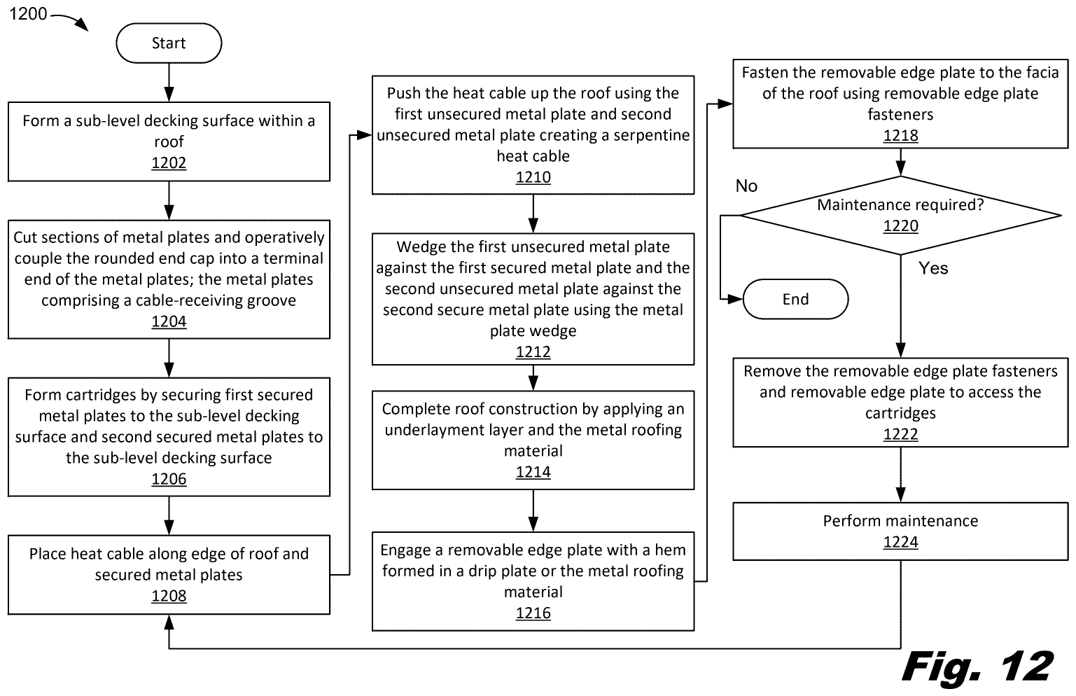

FIG. 12 is a flow diagram illustrating a method 1200 of installing a roof-installed heat cable system according to an embodiment of the present disclosure. This method 1200 may be completed to form and maintain the roof-installed heat cable system described herein such as in FIGS. 1 through 11.

The method 1200 includes, at block 1202, forming a sub-level decking surface on a roof. This sub-level decking surface is described and shown in FIG. 5 for example. In an embodiment, the sub-level decking surface may include dropping a level of the primary roof decking at or along an edge or edges of the roof. The depth of the sub-level decking surface relative to the primary roof decking may be sufficient to place the metal plates described herein into the sub-level decking surface without extending past the lip between the sub-level decking surface and primary roof decking while also allowing the metal plates to come in contact with the metal roofing material via, for example, a underlayment layer such that thermal energy at the metal plates may be transferred into the metal roofing material.

At block 1204, the method 1200 further includes cutting sections of metal plates and operatively coupling the rounded end caps into a terminal ends of the metal plates. As described herein, the total length of the metal plates and the height of the rounded end caps may not exceed the length of the sub-level decking surface formed in the roof such that the metal plates do not extend past an edge of the roof. In an embodiment, the metal plates each comprise a cable-receiving groove meant to receive a heat cable. The cable-receiving grooves may be formed on a side surface of each of the metal plates such that two of the metal plates may align and form channels between those metal plates. In an embodiment, the formed channel may entirely circumvent or surround the heat cable when installed such that the entire outer surface of the heat cable is in physical contact with two metal plates thereby distributing the heat from the heat cable touching the metal plates into those metal plates. It is appreciated that, in some example embodiments, the entire outer surface of the heat cable that is sandwiched between two of the metal plates may not be in physical contact with the metal plates. Although this reduced or limited physical contact between the metal plates 104 and heat cable may be present in the roof-installed heat cable system, heat may still be distributed into the metal plates and is still sufficient to heat the metal roof and prevent ice dams from forming.

The method 1200 also includes, at block 1206, forming cartridges by securing first secured metal plates to the sub-level decking surface and second secured metal plates to the sub-level decking surface. The positioning of the first secured metal plates and second secured metal plates may be dependent on the size of those unsecured metal plates that are placed in between the first secured metal plates and second secured metal plates. As described herein, a number of fasteners may be passed through the first secured metal plates and second secured metal plates and into the sub-level decking surface in order to secure these metal plates in place.

The method 1200 also includes, at block 1208, placing the heat cable along edge of roof and secured metal plates in preparation for installation within the cartridges. Again, the heat cable may be any type of heat cable and the present specification contemplates that any type of heat cable used. In specific examples, the heat cable may be self-regulating heat cables, constant wattage heat cables, mineral insulate (MI) heat cables, series resistance heat cables, or cables that include variations of these features. It is appreciated that the heat cable may be of various wattage and physical sizes with various cross-sectional shapes. In an embodiment, the cross-sectional shapes of the heat cable may be oval, elongated circular, or round. The selected cross-sectional shape of the heat cable may be selected based on the cable-receiving groove formed into the side of the metal plates described herein. For example, where the channel formed between two metal plates with the cable-receiving grooves has an elongated circular shape or an oval shape, the cross-sectional shape of the heat cable may have a complimentary shape such that a maximum amount of the outer surface of the heat cable touches the interior surface of the channel formed between the cable-receiving grooves of the metal plates.

At block 1210, the method 1200 includes pushing the heat cable up the roof using the first unsecured metal plate and second unsecured metal plate creating a serpentine heat cable within the cartridges. As described herein, in order to prevent damage to the heat cable, each of the metal plates include the rounded end caps. Each of the rounded end caps may, in an embodiment, be made of plastic such that the heat cable may pass smoothly across the surface of the end caps. Therefore, during installation of the heat cable, the first unsecured metal plates and second unsecured metal plates may be pushed upwards, towing the heat cable up and into position as shown in FIG. 2, for example. The rounded end caps of these unsecured metal plates may prevent the heat cable from rubbing against a metal surface of the metal plates thereby preventing damage to the heat cable during installation and maintenance of the roof-installed heat cable system.

At block 1212, the method 1200 also includes wedging the first unsecured metal plate against the first secured metal plate and the second unsecured metal plate against the second secure metal plate using the metal plate wedge. These metal plate wedges may be placed between the first unsecured metal plate and the second unsecured metal plate of each cartridge such that these unsecured metal plates are pressed against the secured metal plates. This metal plate wedge secures these unsecured metal plates in place until a maintenance worker, technician, or the homeowner needs to repair the roof-installed heat cable system.

The method 1200 also includes completing roof construction by applying an underlayment layer and the metal roofing material at block 1214 in an embodiment. In another embodiment, a metal cleat or plate may be screwed down on top of the roof-installed heat cable system. In this embodiment, the metal cleat or plate may serve as a hold point for the hemming of the metal roofing panel. It is appreciated that any other layers or materials may be used to complete the roof. In this arrangement, the roof-installed heat cable system is hidden directly below the metal roofing material and is accessible to a maintenance worker, technician, or homeowner laterally from the edge of the roof.

At block 1216, the method 1200 includes engaging a removable edge plate with a hem formed in a drip plate or the metal roofing material. This engagement of the removable edge plate with the hem allows the removable edge plate to keep water from entering under the metal roofing material. At block 1218, the removable edge plate may then be fastened to the facia of the roof using removable edge plate fasteners. Again, these removeable edge plate fasteners may be screws that allow a maintenance worker, technician, or the homeowner toe easily remove the removeable edge plate fasteners in order to begin the process of servicing the roof-installed heat cable system as described herein.

At some point, a maintenance worker, technician, or homeowner may wish to gain access to the roof-installed heat cable system in order to perform maintenance on the roof-installed heat cable system. Therefore, at block 1220, the method 1200 includes determining if maintenance on the roof-installed heat cable system is required. Various indications such as lack of heating of ice dams on the roof may indicate to the maintenance worker, technician, or homeowner that maintenance is required. Where, at block 1220, the maintenance worker, technician, or homeowner determines that maintenance is not required, the method 1200 may end here. However, where, at block 1220, the maintenance worker, technician, or homeowner determines that maintenance is required, the method 1200 continues to block 1222.

At block 1222, the method 1200 includes a maintenance worker, technician, or homeowner removing the removable edge plate fasteners and removable edge plate to access the cartridges previously formed under the metal roofing material. Again, this does not require the maintenance worker, technician, or homeowner to tear up the roofing material or the underlayment layer to gain access to the roof-installed heat cable system. Indeed, the arrangement of the metal plates and the heat cable as described in connection with blocks 1206 through 1212 allows the maintenance worker, technician, or homeowner to perform easy maintenance to the roof-installed heat cable system by gaining access to the roof-installed heat cable system form a lateral direction.

At block 1224, maintenance may be performed on the roof-installed heat cable system. Again, if the heat cable needs to be repaired or replaced, this maintenance may include the maintenance worker, technician, or homeowner removing each of the metal plates wedges, removing each of the unsecured metal plates, and removing the heat cable to address the detected issues. Where maintenance is completed, the method 1200 continues back to block 1208 with the maintenance worker, technician, or homeowner reassembling the cartridges as described herein.

The processes or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A roof-installed heat cable system comprising:
a plurality of metal plate cartridges disposed on a portion of a roof comprising:
a first secured metal plate;
a second secured metal plate; and
one or more unsecured metal plates disposed between the first secured metal plate and the second secured metal plate, wherein each of the first secured metal plate, the second secured metal plate, and the one or more unsecured metal plates includes a cable-receiving groove, the cable-receiving grooves being configured to align and form channels between the first secured metal plate and the one or more unsecured metal plates and between the second secured metal plate and the one or more unsecured metal plates; and
a heat cable disposed between the first secured metal plate and the one or more unsecured metal plates and between the second secured metal plate and the one or more unsecured metal plates.

2. The roof-installed heat cable system of claim 1 further comprising:
one or more wedges configured to mechanically secure the one or more unsecured metal plates against the first secured metal plate and the second secured metal plate when installed.

3. The roof-installed heat cable system of claim 1 further comprising:
the one or more unsecured metal plates comprising rounded plastic inserts at their terminal ends, the rounded plastic inserts being shaped to guide the heat cable around the terminal ends of the unsecured metal plates.

4. The roof-installed heat cable system of claim 1, wherein the first secured metal plate and second secured metal plate of each of the plurality of metal plate cartridges are secured to a sub-level decking surface of a roof that is recessed below a primary roof decking to accommodate the plurality of metal plate cartridges in a flush-mounted configuration.

5. The roof-installed heat cable system of claim 1, wherein a metal roofing layer is installed over the plurality of metal plate cartridges with each of the plurality of metal plate cartridges being accessible via lateral access along the edge of the roof for servicing and maintenance of the roof-installed heat cable system.

6. The roof-installed heat cable system of claim 5 further comprising:
a removable edge plate installed along a lateral edge of the roof to seal the plurality of metal plate cartridges under the metal roofing layer, wherein the removable edge plate is configured to prevent the ingress of water while maintaining access to the plurality of metal plate cartridges.

7. The roof-installed heat cable system of claim 1, wherein the heat cable is arranged in a serpentine pattern between the first secured metal plate and the one or more unsecured metal plates and between the second secured metal plate and the one or more unsecured metal plates.

8. A roof-installed heat cable system concealed under a metal roof and serviceable via lateral access comprising:
a plurality of metal plate cartridges disposed on a portion of a roof comprising:
a first secured metal plate;
a second secured metal plate; and
one or more unsecured metal plates disposed between the first secured metal plate and the second secured metal plate, wherein each of the first secured metal plate, the second secured metal plate, and the one or more unsecured metal plates includes a cable-receiving groove, the cable-receiving grooves being configured to align and form channels between the first secured metal plate and the one or more unsecured metal plates and between the second secured metal plate and the one or more unsecured metal plates;
a heat cable disposed between the first secured metal plate and the one or more unsecured metal plates and between the second secured metal plate and the one or more unsecured metal plates; and
a wedge configured to be inserted between the one or more unsecured metal plates to force them into engagement with the first secured metal plate and the second secured metal plate.

9. The roof-installed heat cable system of claim 8 further comprising:
the one or more unsecured metal plates comprising rounded plastic inserts at their terminal ends, the rounded plastic inserts being shaped to guide the heat cable around the terminal ends of the unsecured metal plates.

10. The roof-installed heat cable system of claim 8, wherein the first secured metal plate and second secured metal plate of each of the plurality of metal plate cartridges are secured to a sub-level decking surface of a roof that is recessed below a primary roof decking to accommodate the plurality of metal plate cartridges in a flush-mounted configuration.

11. The roof-installed heat cable system of claim 8, wherein a metal roofing layer is installed over the plurality of metal plate cartridges with each of the plurality of metal plate cartridges being accessible via the lateral access along the edge of the roof for servicing and maintenance of the roof-installed heat cable system.

12. The roof-installed heat cable system of claim 11 further comprising:
a removable edge plate secured along the lateral edge of the roof including a mating interface to mate with a hem formed at an edge of a drip edge disposed under the metal roofing layer to seal the plurality of metal plate cartridges under the metal roofing layer, wherein the removable edge plate is configured to prevent the ingress of water while maintaining access to the plurality of metal plate cartridges.

13. The roof-installed heat cable system of claim 12, wherein the removable edge plate includes removable fasteners to allow removal of the removable edge plate during maintenance of the roof-installed heat cable system.

14. The roof-installed heat cable system of claim 8, wherein the heat cable is arranged in a serpentine pattern between the first secured metal plate and the one or more unsecured metal plates and between the second secured metal plate and the one or more unsecured metal plates.

15. A roof-installed heat cable system formed on a sub-level decking surface of a roof that is recessed below a primary roof decking, comprising:
a plurality of metal plate cartridges disposed on a portion of a roof comprising:
a first secured metal plate;
a second secured metal plate; and
one or more unsecured metal plates disposed between the first secured metal plate and the second secured metal plate, wherein each of the first secured metal plate, the second secured metal plate, and the one or more unsecured metal plates includes a cable-receiving groove, the cable-receiving grooves being configured to align and form channels between the first secured metal plate and the one or more unsecured metal plates and between the second secured metal plate and the one or more unsecured metal plates;
a heat cable disposed between the first secured metal plate and the one or more unsecured metal plates and between the second secured metal plate and the one or more unsecured metal plates; and
a removable edge plate secured along the lateral edge of the roof including a mating interface to mate with a hem formed in a drip edge disposed under a metal roofing layer to seal the plurality of metal plate cartridges under the metal roofing layer, wherein the removable edge plate is configured to prevent the ingress of water while maintaining access to the plurality of metal plate cartridges.

16. The roof-installed heat cable system 15 further comprising:
the one or more unsecured metal plates comprising rounded plastic inserts at their terminal ends, the rounded plastic inserts being shaped to guide the heat cable around the terminal ends of the unsecured metal plates.

17. The roof-installed heat cable system 15, wherein the first secured metal plate and second secured metal plate of each of the plurality of metal plate cartridges are secured to a sub-level decking surface of a roof that is recessed below a primary roof decking surface to accommodate the plurality of metal plate cartridges in a flush-mounted configuration.

18. The roof-installed heat cable system 15, wherein a metal roofing layer is installed over the plurality of metal plate cartridges with each of the plurality of metal plate cartridges being accessible via the lateral access along the edge of the roof for servicing and maintenance of the roof-installed heat cable system.

19. The roof-installed heat cable system 15, wherein the removable edge plate includes removable fasteners to allow removal of the removable edge plate during maintenance of the roof-installed heat cable system.

20. The roof-installed heat cable system 15, wherein the heat cable is arranged in a serpentine pattern between the first secured metal plate and the one or more unsecured metal plates and between the second secured metal plate and the one or more unsecured metal plates.
